(19) United States
(12) Patent Application Publication
(10) Pub. No.: US 2024/0085312 A1
(43) Pub. Date: Mar. 14, 2024

(54) COLOR SENSING DEVICE

(71) Applicant: ROHM CO., LTD., Kyoto (JP)

(72) Inventors: Tadashi KOBAYASHI, Kyoto (JP); Shiori AZUMA, Kyoto (JP)

(21) Appl. No.: 18/516,111

(22) Filed: Nov. 21, 2023

Related U.S. Application Data
(63) Continuation of application No. PCT/JP2022/021217, filed on May 24, 2022.

(30) Foreign Application Priority Data
May 27, 2021 (JP) 2021-089108

(51) Int. Cl. G01N 21/25

(52) U.S. Cl. CPC G01N 21/251

(57) ABSTRACT

A color sensing device (8) includes: a light source (6) that shines white light to a measurement target object (3); a color sensor (5) that receives the light reflected from the measurement target object to output an R (red) component sensed value, a G (green) component sensed value, and a B (blue) component sensed value each with a first predetermined number of bits; and a converter (7) that converts the R, G, and B component sensed values output from the color sensor respectively into sensed values each with a second predetermined number of bits smaller than the first predetermined number of bits based on the respective maximum values of R, G, and B component measured values measured in advance by a color sensor with respect to a plurality of kinds of measurement target objects.

### CROSS-REFERENCE TO RELATED APPLICATIONS

This nonprovisional application is a continuation application of International Patent Application No. PCT/JP2022/021217 filed on May 24, 2022, which claims priority Japanese Patent Application No. 2021-089108 filed on May 27, 2021, the entire contents of which are hereby incorporated by reference.

### TECHNICAL FIELD

The invention disclosed herein relates to color sensing devices.

### BACKGROUND ART

Color sensors that sense the color components (RGB) of light are known (see, e.g., Patent Document 1 identified below).

### CITATION LIST

### Patent Literature

Patent Document 1: JP-A-2020-129756

### BRIEF DESCRIPTION OF DRAWINGS

FIG. 1 is a diagram showing a configuration example of a color sensing device.

FIG. 2 is a diagram showing a configuration example of a color sensor.

FIG. 3 is a diagram showing one example of the positional relationship of a measurement target object with a circuit board (as seen from a direction parallel to the circuit board).

FIG. 4 is a diagram showing one example of the positional relationship of a measurement target object with a circuit board (as seen from a direction perpendicular to the circuit board).

FIG. 5 is a table showing an example of results of 8-bit conversion of RGB component sensed values.

FIG. 6A is a graph showing the R (red)-G (green) correlation of the converted sensed values shown in FIG. 5.

FIG. 6B is a graph showing the G-B (blue) correlation of the converted sensed values shown in FIG. 5.

FIG. 6C is a graph showing the B-R correlation of the converted sensed values shown in FIG. 5.

FIG. 7 is a table showing another example of results of 8-bit conversion of RGB component sensed values.

FIG. 8A is a graph showing the R-G correlation of the converted sensed values shown in FIG. 7.

FIG. 8B is a graph showing the G-B correlation of the converted sensed values shown in FIG. 7.

FIG. 8C is a graph showing the B-R correlation of the converted sensed values shown in FIG. 7.

FIG. 9 is a diagram schematically showing a configuration example of an image forming apparatus.

### DESCRIPTION OF EMBODIMENTS

Illustrative embodiments of what is disclosed herein will be described below with reference to the accompanying drawings.

### 1. Configuration of a Color Sensing Device

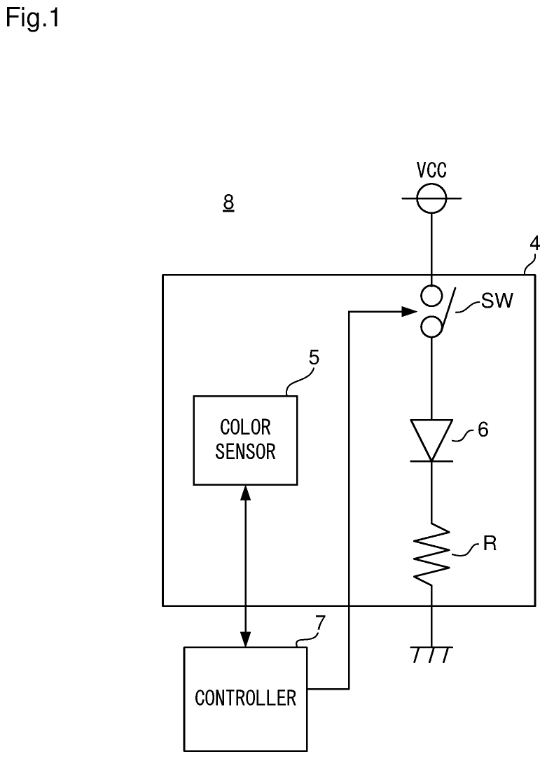

FIG. 1 is a diagram showing a configuration example of a color sensing device. As shown in FIG. 1, the color sensing device 8 includes a circuit board 4, a color sensor 5, a white LED 6, a controller 7, a switch SW, and a resistor R. The color sensor 5, the white LED 6, the switch SW, and the resistor R are mounted on the circuit board 4. The controller 7 is, for example, a microprocessor. From a supply voltage VCC, electric power is supplied to different parts of the color sensing device 8.

The white LED 6 is a chip LED that emits white light. The switch SW and the resistor R are arranged in a path across which a current from the supply voltage VCC passes through the white LED 6. The switch SW is turned on and off by the controller 7. As the switch SW is turned on and off, the white LED 6 is switched between a lit and an extinguished state. The resistor R limits the current through the white LED 6 to adjust the amount of white light emitted.

The color sensor 5 is a sensor IC that can sense the color components of light. The color components are, specifically, an R component (red component), a G component (green component), and a B component (blue component). When the controller 7 turns the switch SW on, the white LED 6 emits white light. The white LED 6 shines the white light onto a measurement target object. The color sensor 5 receives the light reflected from the measurement target object and senses the color components. The color sensor 5 feeds the sensed color components in the form of digital data to the controller 7. The digital data that the color sensor 5 outputs is, for example, 16-bit data. The controller 7 converts the sensed values of the RGB components (hereinafter RGB component sensed values) that are acquired from the color sensor 5 each in the form of 16-bit data each into, for example, 8-bit data.

### 2. Configuration of the Color Sensor

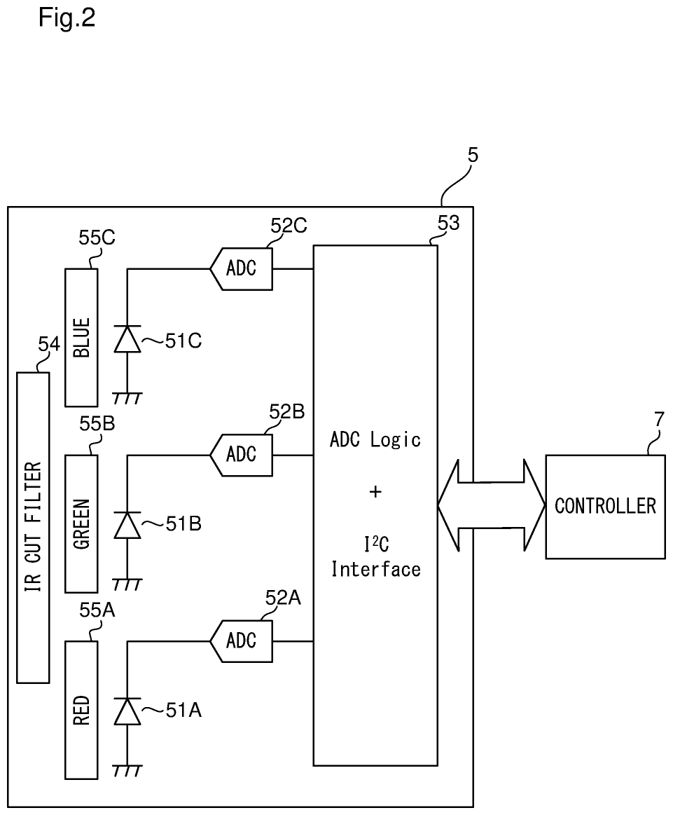

FIG. 2 is a diagram showing a configuration example of the color sensor 5. The color sensor 5 shown in FIG. 2 includes photosensitive elements 51A, 51B, and 51C, ADCs (AD converters) 52A, 52B, and 52C, a logic circuit 53, an infrared cut filter 54, a red pass filter 55A, a green pass filter 55B, and a blue pass filter 55C.

The photosensitive element 51A generates an analog current signal that reflects the amount of red light incident through the infrared cut filter 54 and the red pass filter 55A. That is, the photosensitive element 51A senses the R component (red component) of the incident light.

The photosensitive element 51B generates an analog current signal that reflects the amount of green light incident through the infrared cut filter 54 and the green pass filter 55B. That is, the photosensitive element 51B senses the G component (green component) of the incident light.

The photosensitive element 51C generates an analog current signal that reflects the amount of blue light incident through the infrared cut filter 54 and the blue pass filter 55C. That is, the photosensitive element 51C senses the B component (blue component) of the incident light.

The photosensitive elements 51A, 51B, and 51C can each be implemented suitably with a photodiode, a phototransistor, or the like.

The ADCs 52A, 52B, and 52C convert the analog current signals from the photosensitive elements 51A, 51B, and 51C into, for example, 16-bit digital data and output the results.

The infrared cut filter 54 cuts an infrared component IR in the incident light upstream of all of the red pass filter 55A, the green pass filter 55B, and the blue pass filter 55C. Providing the infrared cut filter 54 allows accurate sensing of the RGB components.

The logic circuit 53 has an ADC logic function (a function of controlling time division in ADCs) and an 12C interface function (a function of communicating a data signal SDA and a clock signal SCL). The logic circuit 53 feeds the digital data output, as RGB component sense signals, from the ADCs 52A, 52B, and 52C to the controller 7 by I2C communication.

### 3. Position of a Measurement Target Object

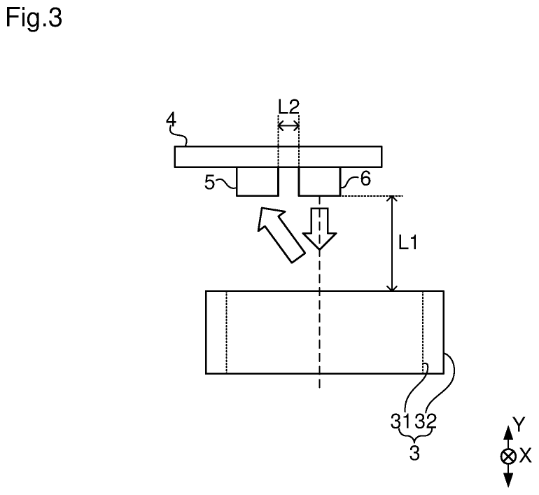

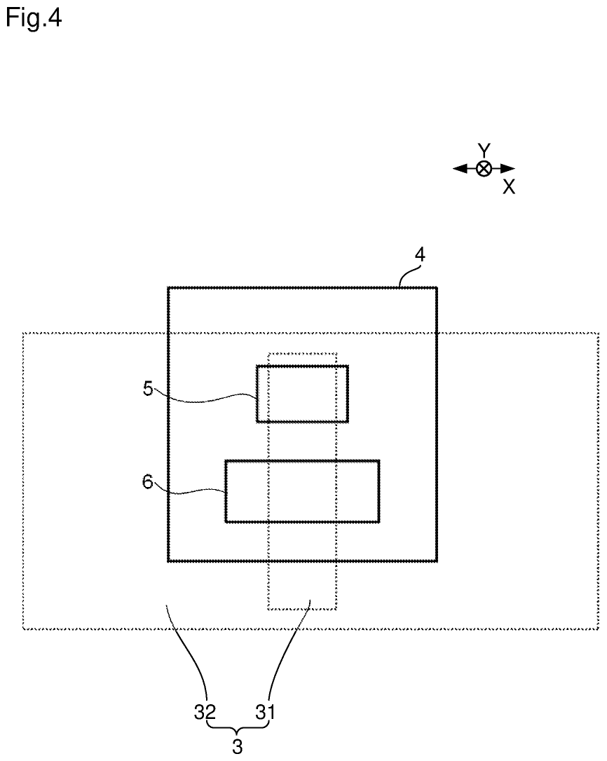

FIGS. 3 and 4 show one example of the positional relationship of a measurement target object 3 with the circuit board 4. FIG. 3 shows the measurement target object 3 as seen from a direction, X, parallel to the board surface of the circuit board 4. FIG. 4 shows the same as seen from a direction, Y, perpendicular to the board surface of the circuit board 4 (hereinafter mentioned simply as perpendicular(ly)). The measurement target object 3 is composed of a first measurement target 31 and a second measurement target 32. While the second measurement target 32 has a predetermined color, the first measurement target 31 can be of any color. The color sensing device 8 is intended to sense the color of the first measurement target 31 within the measurement target object 3. Note that the first and second measurement targets 31 and 32 can be arranged in any positional relationship and can be given any shapes other than as shown in FIGS. 3 and 4.

As indicated by arrows in FIG. 3, the white light from the white LED 6 is shone onto the measurement target object 3 and the reflected light from the measurement target object 3 is received by the color sensor 5.

Moreover, as shown in FIG. 4, the area corresponding to the white LED 6 projected perpendicularly onto the measurement target object 3 overlaps the first measurement target 31. Thus, the white light from the white LED 6 can be shone onto the first measurement target 31 and the reflected light from the first measurement target 31 can be received by the color sensor 5. As shown in FIG. 4, the area corresponding to the white LED 6 projected perpendicularly onto the measurement target object 3 overlaps the second measurement target 32 as well. Thus, the white light from the white LED 6 can be shone also onto the second measurement target 32 and the reflected light from the second measurement target 32 can be received by the color sensor 5. Accordingly, the color sensing by the color sensor 5 with respect to the first measurement target 31 takes into consideration also the color of the second measurement target 32. A configuration is also possible where the area corresponding to the white LED 6 projected perpendicularly onto the measurement target object 3 only overlaps the first measurement target 31. In that case, the second measurement target 32 is excluded from the measurement target and is treated as a part other than the first measurement target 31, with the white light shone onto, out of the first measurement target 31 and the just-mentioned part, only the first measurement target 31.

The distance L1, shown in FIG. 3, between the white LED 6 and the measurement target object 3 in the perpendicular direction is preferably such that the light received by the color sensor 5 is neither too bright nor too dim. In a case where the design requires a short distance L1, the amount of light from the white LED 6 can be adjusted by limiting it with the resistor R. The resistor R may be a variable resistor.

On the other hand, the distance L2, shown in FIG. 3, between the white LED 6 and the color sensor 5 along the board surface is preferably such that as little white light as possible is directly received by the color sensor 5. A wall that cuts white light may be provided between the white LED 6 an the color sensor 5.

Mounting the white LED 6 and the color sensor 5 on the same circuit board 4 helps reduce variation in the positional relationship among the white LED 6, the color sensor 5, and the measurement target object 3.

### 4. Method of Color Sensing

Now, a description will be given of how the color sensing device 8 senses a color. In advance, a number of first measurement targets 31 with different colors are each irradiated with white light from a white LED and the reflected light is received by a color sensor so that it senses the RGB components.

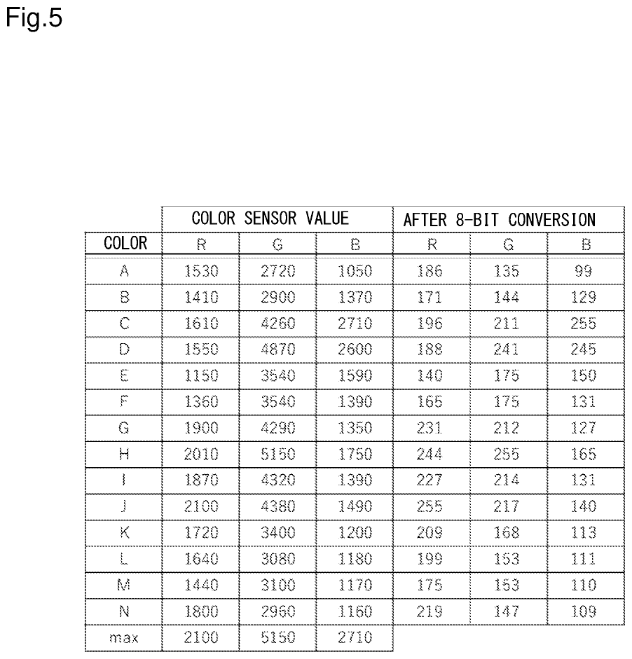

As one example, FIG. 5 shows the results of color component sensing performed as described above with a color sensor with respect to each of first measurement targets 31 with colors A to N. In FIG. 5, in the columns of “COLOR SENSOR VALUES” are listed the RGB component sensed values acquired for each first measurement target 31. Those RGB component sensed values are each a 16-bit value (from 0 to 65535). Note that, as mentioned earlier, the “color sensor values” listed in FIG. 5 are those with respect to the first measurement target 31 with the color of the second measurement target 32 also taken into consideration.

Then, from the RGB component sensed values measured with a color sensor in advance as described above, the maximum values are calculated for the RGB components respectively. The maximum values so calculated for the RGB components are stored in the controller 7 in advance.

Then the controller 7, by making the white LED 6 shine white light onto the first measurement target 31 and making the color sensor 5 receive the reflected light from the first measurement target 31, senses the RGB components. The controller 7 then converts the RGB component sensed values (16-bit data per component) output from the color sensor 5 into RGB components in the form of 8-bit data per component. Here, the conversion of the RGB component sensed values into 8-bit values is performed, on the assumption that the maximum value of each component corresponds to 255, which is the maximum value of a 8-bit value, based on the ratios, to the just-mentioned maximum value, of the RGB component sensed values output from the color sensor 5. That is, the conversion into 8-bit sensed values is performed according to Formula (1) below:

DET*(8 bit)=255×(DET*(16 bit)/MAX*) (1)

Here, DET*(8 bit) is a sensed value after conversion into 8 bits, DET*(16 bit) is a sensed value in 16 bits, MAX is a maximum value acquired in advance, and * stands for one of R, G, and B distinguishing components.

In the example shown in FIG. 5, the maximum values of the RGB component sensed values from the color sensor 5 are “2100”, “5150”, and “2710” respectively. The values that result from conversion, using those maximum values, into 8-bit sensed values with respect to each first measurement target 31 according to Formula (1) above are shown in FIG. 5 (“AFTER 8-BIT CONVERSION” in FIG. 5).

Here, if a white color is available that serves as a reference for the first measurement target 31, a first measurement target 31 with that white color can be irradiated with white light and the reflected light can be received with the color sensor 5 so that the RGB component sensed values thus measured can be used as the reference white color. That is, the RGB component sensed values so acquired can be taken as corresponding to 255 in the conversion of the sensed values from the color sensor 5 into 8-bit sensed values.

Inconveniently, a first measurement target 31 with a reference white color as mentioned above is not always available. Even in such a case, according to this embodiment, conversion into 8-bit sensed values is possible by using, as a virtual reference while color, the color represented by the maximum values of the RGB component sensed values calculated as described above.

### 5. Modified Example of a Method of Color Sensing

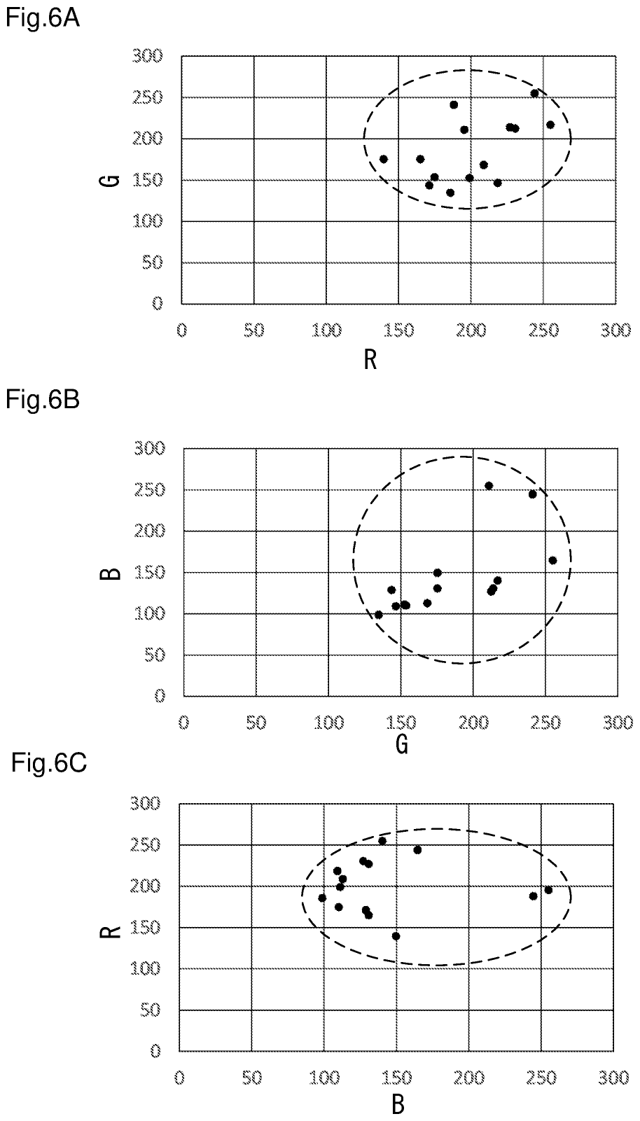

The RGB component sensed values after 8-bit conversion described above and shown in FIG. 5 can be plotted, in terms of R-G, G-B, and B-R correlations, in graphs as shown in FIGS. 6A, 6B, and 6C respectively. In the example shown in FIG. 5 the amount of light from the white LED 6 is so small as to result in small differences, due to differences among the colors of the first measurement targets 31, in the RGB component sensed values from the color sensor 5. Thus, as shown in FIGS. 6A to 6C, the sensed values after 8-bit conversion are lopsided toward 255, all the first measurement targets 31 tending to exhibit whitish colors. That is, it is difficult to discriminate subtle differences among the colors of the first measurement targets 31.

So, it is also possible to adopt a modified example of a method of color sensing as described below. Here, in advance, from the RGB component sensed values measured with a color sensor, the maximum values of those components are respectively calculated as described above, and in addition the minimum values of those components are respectively calculated so that the so calculated minimum values too are stored in the controller 7.

The controller 7 then converts the RGB component sensed values (16-bit data) sensed by the color sensor 5 with respect to each first measurement target 31 into 8-bit sensed values. Here, the above-mentioned maximum value of each component is assumed to correspond to 255, which is the maximum value of 8 bits, and the above-mentioned minimum value of each component is assumed to correspond to a predetermined minimum 8-bit value in the conversion of the RGB component sensed values output from the color sensor 5 into 8-bit values. That is, 8-bit conversion is performed according to Formula (2) below.

DET*(8 bit)=(DET*(16 bit)−MIN*)×(255−min)/(MAX*−MIN*)+min (2)

Here, DET*(8 bit) is a sensed value after conversion into 8 bits, DET*(16 bit) is a sensed value in 16 bits, MAX is a maximum value acquired in advance, MIN is a minimum value acquired in advance, * stands for one of R, G, and B distinguishing components, and min is a predetermined minimum 8-bit value.

Here, the above-mentioned predetermined minimum 8-bit value may be zero, but this may lead to too dark a color. To avoid that, so that a value close to a real color as perceived by the human eye can be obtained, it is preferable that the predetermined minimum 8-bit value be set based on the black color of a color sample. For example, as a color sample, TOCOL fan deck-A can be used; based on the black (No. 159; R=47, G=47, B=46) in the color sample, the predetermined minimum 8-bit value can be set to a value around 50; specifically, it can be set to a value between 45 and 55.

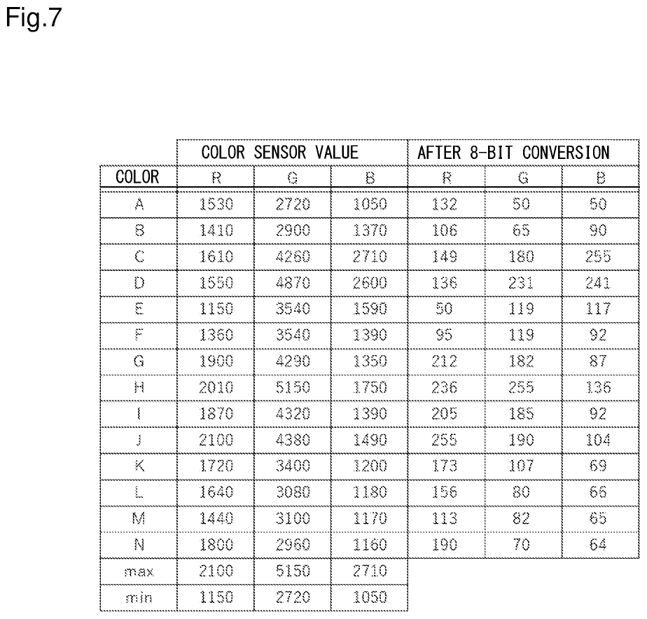

FIG. 7 shows the results of conversion into 8-bit RGB component sensed values according to Formula (2) above with respect to first measurement targets 31 similar to those in FIG. 5. As shown in FIG. 7, the minimum values of the RGB component sensed values from the color sensor 5 are “1150”, “2720”, and “1050”. FIG. 7 shows the results acquired with the predetermined minimum 8-bit value set to “50”.

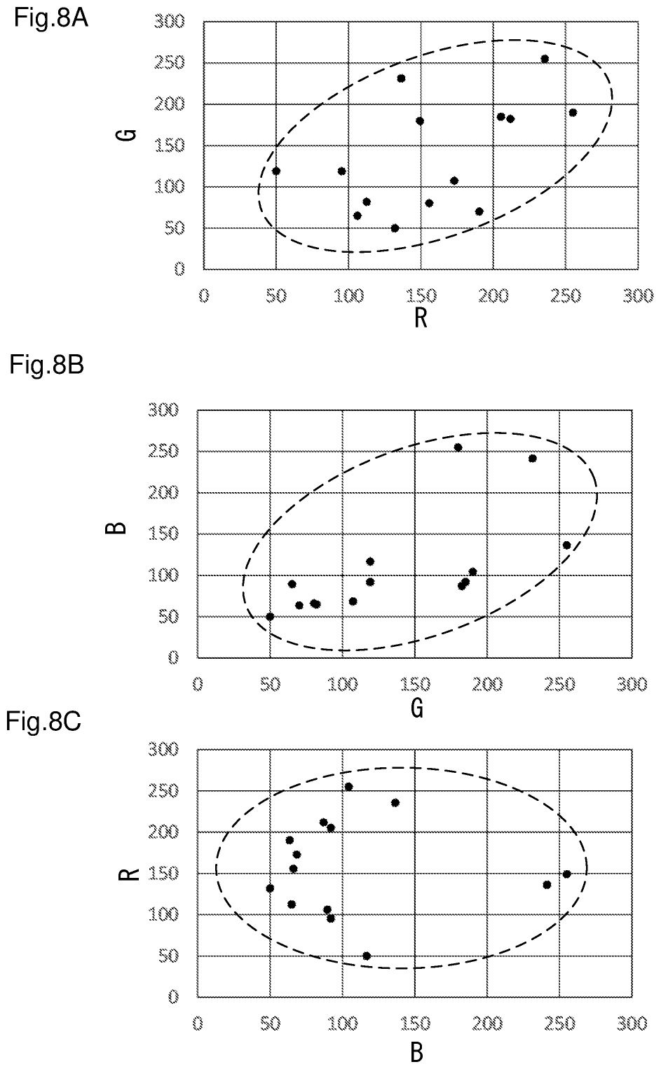

The RGB component sensed values after the 8-bit conversion shown in FIG. 7 can be plotted, in terms of R-G, G-B, and B-R correlations, in graphs as shown in FIGS. 8A, 8B, and 8C respectively. Compared to FIGS. 6A to 6C described previously, in FIGS. 8A to 8C, the RGB component sensed values after 8-bit conversion are dispersed between 50 and 255. Thus it is possible, irrespective of the amount of light from the white LED 6, to enhance the color resolution of color sensing and to discriminate subtle differences among the colors of the first measurement targets 31.

### 6. Application to an Image Forming Apparatus

A color sensor as described above finds many applications. A description will now be given of, as one example of its application, an image forming apparatus. On an image forming apparatus, a capability to discriminate the colors of sheets allows appropriate control of image formation according to the results of discrimination.

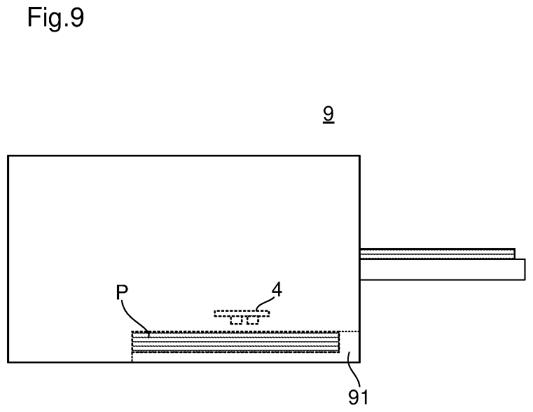

FIG. 9 is a diagram schematically showing a configuration example of an image forming apparatus. The image forming apparatus 9 shown in FIG. 9 includes a sheet feed tray 91; it forms images on sheets P stored in the sheet feed tray 91 and then discharge them. The image forming apparatus 9 also includes, though not shown in FIG. 9, a sheet conveying unit, an image forming unit, a sheet discharge unit, and the like. It can employ any image forming method such as one using ink jets or one using laser light.

In the example shown in FIG. 9, the circuit board 4 is arranged above the sheets P stored in the sheet feed tray 91. Thus, white light can be shone from the white LED 6 onto the sheets P, and the reflected light from the sheets P can be received by the color sensor 5. The controller 7 (not shown in FIG. 9) then converts the RGB component sensed values from the color sensor 5 into 8-bit sensed values. Here, even if no reference white color is specified with respect to the sheets P, by a method like the one in the embodiment described above, it is possible to sense colors based on a virtual reference white color. The circuit board 4 may be arranged elsewhere than as in the example in FIG. 9, and can be arranged, for example, halfway along a sheet conveyance passage.

### 7. Modifications

While an embodiment of the present disclosure has been described above, it can be modified in many ways without departure from the spirit of what is disclosed herein.

For example, the measurement target object 3 may comprise combinations of first measurement targets 31 of the same color with second measurement targets 32 with different colors. For example, in the example shown in FIG. 5, color sensing may be performed with combinations of each of the first measurement targets 31 with colors A to N with a plurality of second measurement targets 32 with different colors. For example, in a case where four kinds of second measurement targets 32 are available, for each of 14×4=56 combinations, RGB component sensed values are sensed by the color sensor 5 and, of the 56 sensed values for each of the RGB components, the maximum value or the minimum value is determined.

It is also possible to measure RGB component sensed values with a color sensor and acquire maximum or minimum values in advance not only with measurement target objects 3 that include first measurement targets 31 but also with measurement target objects 3 that includes no first measurement targets 31.

A measurement target object 3 does not necessarily have to include a first measurement target 31. For example, it is also possible to use second measurement targets 32 with the same variation of colors as the first measurement targets 31 as in an embodiment that uses first measurement targets 31.

### 8. Overview

To follow is an overview of the various embodiments described herein.

For example, according to one aspect of what is disclosed herein, a color sensing device (8) includes:
a light source (6) that shines white light to a measurement target object (3);
a color sensor (5) that receives the reflected light reflected from the measurement target object to output an R (red) component sensed value, a G (green) component sensed value, and a B (blue) component sensed value each with a first predetermined number of bits; and
a converter (7) that converts the R, G, and B component sensed values output from the color sensor respectively into sensed values each with a second predetermined number of bits smaller than the first predetermined number of bits based on the respective maximum values of R, G, and B component measured values measured in advance by a color sensor with respect to a plurality of kinds of measurement target objects. (A first configuration.)

In the first configuration described above, the converter may perform the conversion into the sensed values each with the second predetermined number of bits based on, in addition to the maximum values, the respective minimum values of R, G, and B component sensed values acquired in advance by a color sensor with respect to a plurality of kinds of measurement target objects. (A second configuration.)

In the second configuration described above, the second predetermined number may be eight, and the converter may perform the conversion assuming that the minimum values correspond to values around 50 as represented in eight bits. (A third configuration.)

In any of the first to third configurations described above, the first predetermined number may be sixteen, and the second predetermined number may be eight. (A fourth configuration.)

In any of the first to fourth configurations described above, there may be further provided a resistor (R) arranged in a path across which a current passes to the light source. (A fifth configuration.)

In any of the first to fifth configurations described above, the light source and the color sensor may be mounted on the same circuit board. (A sixth configuration.)

In any of the first to sixth configurations described above, the measurement target object may have a first measurement target (31) and a second measurement target (32), and the light source may shine the white light onto both of the first and second measurement targets. (A seventh configuration.)

In the seventh configuration described above, the maximum values may be values obtained with respect to combinations of a plurality of first measurement targets with different colors with a plurality of second measurement targets with different colors. (An eighth configuration.)

In any of the first to sixth configurations described above, the measurement target object may have a first measurement target (31) and a part (32) other than the first measurement target, and the light source may shine the white light onto, of the first measurement target and the part, only the first measurement target. (A ninth configuration.)

According to another aspect of what is disclosed herein, an image forming apparatus (9) includes the color sensing device according to any of the first to ninth configurations described above, and the measurement target object is a sheet (P).

### INDUSTRIAL APPLICABILITY

The invention disclosed herein finds applications, for example, in color sensing in a variety of devices and appliances.

### REFERENCE SIGNS LIST

3 measurement target object
4 circuit board
5 color sensor
6 white LED
7 controller
8 color sensing device
9 image forming apparatus
31 first measurement target
32 second measurement target
51A, 51B, 51C photosensitive element
52A, 52B, 52C ADC
53 logic circuit
54 infrared cut filter
55A red pass filter
55B green pass filter
55C blue pass filter
91 sheet feed tray
P sheet
R resistor
SW switch

1. A color sensing device comprising:
a light source that shines white light to a measurement target object;
a color sensor that receives reflected light reflected from the measurement target object to output an R (red) component sensed value, a G (green) component sensed value, and a B (blue) component sensed value each with a first predetermined number of bits; and
a converter that converts the R, G, and B component sensed values output from the color sensor respectively into sensed values each with a second predetermined number of bits smaller than the first predetermined number of bits based on respective maximum values of R, G, and B component measured values measured in advance by a color sensor with respect to a plurality of kinds of measurement target objects.

2. The color sensing device according to claim 1, wherein
the converter performs the conversion into the sensed values each with the second predetermined number of bits based on, in addition to the maximum values, respective minimum values of R, G, and B component sensed values acquired in advance by a color sensor with respect to a plurality of kinds of measurement target objects.

3. The color sensing device according to claim 2, wherein
the second predetermined number is eight, and
the converter performs the conversion assuming that the minimum values correspond to values around 50 as represented in eight bits.

4. The color sensing device according to claim 1, wherein
the first predetermined number is sixteen, and
the second predetermined number is eight.

5. The color sensing device according to claim 1, further comprising a resistor arranged in a path across which a current passes to the light source.

6. The color sensing device according to claim 1, wherein
the light source and the color sensor are mounted on the same circuit board.

7. The color sensing device according to claim 1, wherein
the measurement target object has a first measurement target and a second measurement target, and
the light source shines the white light onto both of the first and second measurement targets.

8. The color sensing device according to claim 7, wherein
the maximum values are values obtained with respect to combinations of a plurality of the first measurement targets with different colors with a plurality of the second measurement targets with different colors.

9. The color sensing device according to claim 1, wherein
the measurement target object has a first measurement target and a part other than the first measurement target, and
the light source shines the white light onto, of the first measurement target and the part, only the first measurement target.

10. An image forming apparatus comprising the color sensing device according to claim 1, wherein
the measurement target object is a sheet.
